(19) United States
(12) Patent Application Publication
(10) Pub. No.: US 2016/0150275 A1
(43) Pub. Date: May 26, 2016

(54) SYSTEM AND METHOD FOR DELIVERING 4K MEDIA CONTENTS OR MOVIES ON DISPLAY DEVICE(S)

(71) Applicants: Joydeep Roychowdhury, Powell, OH (US); Ashok Syal, Reston, VA (US)

(72) Inventors: Joydeep Roychowdhury, Powell, OH (US); Ashok Syal, Reston, VA (US)

(21) Appl. No.: 14/554,031

(22) Filed: Nov. 25, 2014

(51) Int. Cl. H04N 21/4363; H04N 21/4405; H04N 21/418; H04N 21/442; H04N 21/2347; H04N 21/258

(52) U.S. Cl. CPC H04N 21/43637; H04N 21/2347; H04N 21/25875; H04N 21/4184; H04N 21/44204; H04N 21/44236; H04N 21/4405

(57) ABSTRACT

The present invention provides a system and method for delivering 4k media contents or movies on display devices such as high definition television via wireless communication. The present invention is a system and method for distributing 4k media contents or movies from data sources to display device through High-Definition Multimedia Interface (HDMI), wherein an interactive wireless network interface is physically connected to High-Definition Multimedia Interface (HDMI) to play 4K media contents or movies on an associated display device from the database.

### FIELD OF THE INVENTION

The present invention relates generally to encrypting, decrypting and transmitting of 4K media contents or movies. More specifically, the invention relates to storing and transmitting of 4K media contents or movies by wireless communication, from a source to a display device through High-Definition Multimedia Interface (HDMI).

### BACKGROUND OF THE INVENTION

Method of distributing information has changed. Today, movies and other types of “playable” data are digitally encoded and distributed either physically on a medium such as a DVD (Digital Video Disc) or are distributed over a network such as the Internet. Based on use of these modern day distribution techniques, users have much more flexibility where and when they watch a movie, listen to music, etc.

Similarly, as the method of distribution has changed so has the quality of large screen, such as ultra-high-definition TV. Manufacturers such as Sony, Toshiba, LG, Samsung, Hi sense, Haier, Skyworth, TCL, Konka, Changhong and other major domestic TV manufacturers this year to launch various types of interfaces that has 4K ultra high-definition technology with even higher resolution. Further, the 4K ultra-high-definition TV (UHDTV) has been developed, which can display ultra-high-definition images presented by an ultra-high-definition video data.

In recent years, the transmission of the media content from a source to a display device is facilitated by interfaces such as High-Definition Multimedia Interface (HDMI). For example, AV source or DVD (Digital Versatile Disc) recorder, set-top boxes, and other products from (Audio Visual source), to the display television receiver, projector, or other digital video signals, and the video signal as a communication interface for transmitting at high speed, and a digital audio signal associated with High Definition Multimedia Interface (HDMI) is becoming popular.

The HDMI is advantageous as high-quality uncompressed data can be securely displayed on a HDCP (High-bandwidth Digital Content Protection) based display device. A lot of display devices such as high-definition plasma/LCD/LED displays, digital projectors, and DVO players are HDMI compatible and comes with a connector to facilitate the high-fidelity transfer of digital content from source devices (e.g. digital set top boxes, DVD players, etc.) to display devices via digital cable or with wireless technology.

There are many applications that a consumer can use on a television or set-top box that allows a consumer to consume media content from various sources. For example, a consumer can select between media content that is delivered linearly from a multichannel video programming distributor, video-on-demand or movies that is provided by a multichannel video programming distributor, personal media content that is acquired by the consumer, recorded content that is stored on a digital video recorder or any other suitable storage device.

As the number of sources continues to increase, media guidance becomes increasingly important. For example, prior to making a decision on which media content to view, the consumer is generally required to select which content source to access either by running a particular application or accessing a particular section in an application.

With advancement in technology there is a demand for devices that process multimedia contents, the demand for more powerful and more efficient processing schemes, without the constraints of handling capacity, resource requirements and processing chips which can directly support native 4K ultra high definition image decoding and playback of transmission. Meanwhile, there are many interfaces that only support FHD transmission interface, and cannot directly support this high-resolution 4K signal. Further, not just 4K ultra high definition images on this level, the future will be towards a higher level of development 8K4K resolution, etc.

On the other hand processing device also includes devices such as dongle for digital rights management protection with digital right management engine and an encryption/decryption engine. The digital right management engine is adapted to port digital rights management rules of a source to digital rights management rules enforced by the digital rights management engine. The encryption/decryption engine is adapted to re-encrypt the source of content into a managed copy of the content and the managed copy of the content is locked to the dongle.

In order to satisfy users' with a high-quality media content, media content providers have been increasingly developing newer technologies with higher specifications of multimedia signal processing and transmitting. To achieve such object, the pre-production and post-production capacities, and the content transmission capacities should be enhanced. Otherwise, the multimedia contents that are produced and tailored in high-quality, hi-definition level could not be properly presented on the high-definition television or smart television.

As Ultra HD TV adoption continues to surge, lack of compelling 4K content has become a problem. Consumer Electronics (CE) manufacturers need to securely deliver content that allows their customers to enjoy the full capabilities of their new TVs. At the same time, content producers and owners are protective of their 4K libraries and demand a robust content protection technology that will ensure 4K content being securely delivered.

Therefore, it would be desirable to provide an improved technique for delivering 4k content on media display and end-to-end digital asset management platform automates many distribution and administrative functions to solve the above-mentioned problem which can work both online or offline.

### SUMMARY OF THE INVENTION

The present invention is a method for delivering 4K media contents or movies on display device, the method comprising: receiving raw video of 4K media contents or movies; encrypting said 4K media contents or movies into proprietary format; storing said media contents or movies into database for wireless transmission; transmitting said 4K media contents or movies into interactive wireless network interface, the interactive wireless network interface is physically connected with High-Definition Multimedia Interface (HDMI) and said 4K media contents or movies are presented to subscriber unit; receiving the subscriber input indicative of a media contents or movies selection; authorizing the subscriber, decrypting the 4K media contents or movies; and delivering 4K media contents or movies by a dongle or wireless adapter connected to the display device.

The present invention an interactive system for delivering 4K media contents or movies on display device, the system comprising: plurality of database; proprietary software; interactive wireless network interface: High-Definition Multimedia Interface (HDMI); and a dongle or wireless adapter; wherein, said database is for storing raw video of 4K media contents or movies; said proprietary software for encrypting and decrypting of 4K media contents or movies for storage and transmission; said interactive wireless network interface is for receiving, storing and transmitting encrypted 4K media contents or movies; said High-Definition Multimedia Interface (HDMI) is physically connected to interactive wireless network interface which store the 4K media contents or movies for presenting to the subscriber unit; and a dongle or wireless adapter connected to display device for transmitting the decrypted 4K media contents or movies to display device through wireless communication network.

One advantage of the present invention is that a dongle or wireless adapter have expansion slot micro SD card for downloading, streaming and storing the 4K media contents or movies to watch offline.

Another advantage of the present invention is that the dongle or wireless adapter has remote connect feature to monitor usage static or illegal distribution of media contents or movies.

### BRIEF DESCRIPTION OF THE DRAWINGS

The following invention will be described with reference to the following drawings. The drawings and the associated descriptions are provided to illustrate embodiments of the invention and not to limit the scope of the invention:

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an exemplary schematic configuration block diagram illustrating 4K media contents or movies delivery system according to an embodiment;

FIG. 2 is an exemplary schematic configuration block diagram illustrating a 4K media contents or movies delivery to electronic devices;

FIG. 3 is an exemplary schematic functional configuration block diagram illustrating a method for delivering of 4K media contents or movies to display devices.

FIG. 4 is an exemplary schematic functional configuration block diagram illustrating a method for delivering of 4K media contents or movies to user or subscriber.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

### DEFINITION(S)

The term “4K media contents or movies” are audio or video or combination thereof.

The term “Database” is having plurality of database with proprietary software for storing 4K media contents or movies encrypted into proprietary format. Also allows users to connect and log into the system using a terminal program. Once logged in, a user can perform functions such as uploading and downloading such as bulletin board system (BBS).

The term “Interactive wireless network interface” is specialized hardware and software designed that provides access to information and applications for communication, transmission 4K media contents or movies on wireless network.

The term “High-Definition Multimedia Interface (HDMI)” is a compact audio/video interface for transferring 4k media contents or movies data from an HDMI-compliant source to display device.

The term “dongle OR wireless adapter” is a hardware incorporating proprietary software that attaches to computer, TV, or other electronic device for streaming and downloading 4K media contents or movies form internet. The dongle OR wireless adapter is for delivery of 4K media contents or movies having expansion slot microSD to add more memory via micro sd card in memory 32, 64, 128 GB incorporated with compression and de-compression software and—encryption and de-encryption software. This is also having MicroUSB port for diagnostics, power supply etc.

One embodiment of the present invention is an interactive system for delivering 4K media contents or movies on display devices, the system comprising: plurality of database; proprietary software module; an interactive wireless network interface; High-Definition Multimedia Interface (HDMI); and a dongle or wireless adapter; wherein, said database is for storing raw video of 4K media contents or movies; said proprietary software module for encrypting and decrypting of 4K media contents or movies for storage and transmission; said interactive wireless network interface is for receiving, storing and transmitting encrypted 4K media contents or movies; said High-Definition Multimedia Interface (HDMI) is physically connected to interactive wireless network interface which store the 4K media contents or movies for presenting to the subscriber unit; and a dongle or wireless adapter connected to display device for transmitting the decrypted 4K media contents or movies to display device through wireless communication network.

The dongle or wireless adapter used is password protected, so that if it is lost someone else cannot watch or use the 4K media contents or movies from the dongle. The dongle or wireless adapter will store or remember the display device's ID it is playing on and a user shall not have to enter the password or PIN every time. The password or PIN is only required for the first time on a display device. The a dongle or wireless media adapter have expansion micro SD card slot for downloading, streaming and storing the 4K media contents or movies to watch offline. The micro SD card memory is expandable to 32, 64, 128 GB or more. The dongle or wireless adapter also has a remote connect feature to monitor usage static or illegal distribution of 4K media contents or movies. The dongle or wireless adapter communicatively couples to any electronic device such as laptops or computers or mobile phones or land line phones; and communicates the 4K media contents or movies data to a web browser of the electronic device via a web server to the dongle or wireless adapter.

The interactive wireless network interface and High-Definition Multimedia Interface (HDMI) in combination physically stores the 4K media contents or movies for presenting to the subscriber unit for rental. The 4K media contents or movies stored will be removed from the subscriber unit after specific time duration of rental.

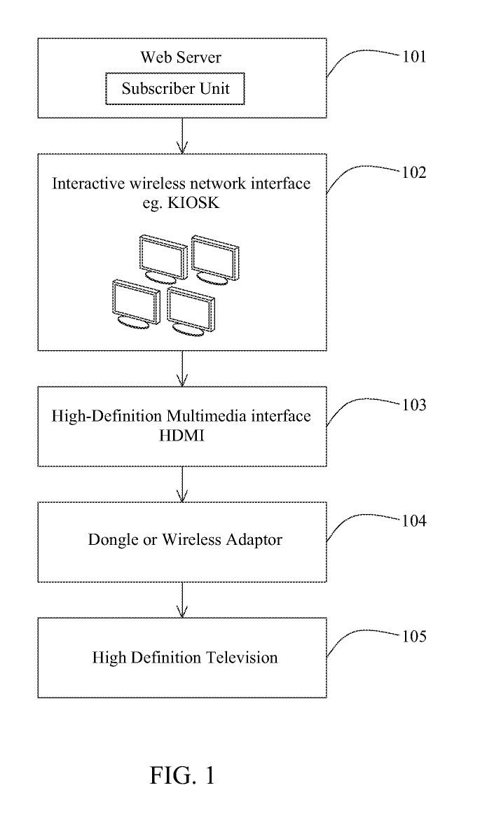

As illustrated in FIG. 1, an interactive system for delivering 4K media contents or movies on display devices, wherein the web server 101 having subscriber unit for user or subscriber to log into the present system. The system comprising of plurality of databases; an interactive wireless network interface such as KIOSK 102 and High-Definition Multimedia Interface (HDMI) 103 incorporated with proprietary software module for delivering 4K media contents or movies with a dongle or wireless adapter 104 on high definition television 105. The database is for storing raw video of media contents or movies on said proprietary software module for encrypting and decrypting of 4K media contents or movies for storage and transmission. The said interactive wireless network interface 102 is for receiving, storing and transmitting encrypted 4K media contents or movies, wherein the said High-Definition Multimedia Interface (HDMI) 103 is physically connected to interactive wireless network interface 102 which stores the 4K media contents or movies for presenting to the subscriber unit; and a dongle or wireless adapter 104 is connected to high definition television 105 for transmitting the decrypted 4K media contents or movies through wireless communication network.

Another embodiment of the present invention provide a system of 4K media contents or movies delivery to display device, the system comprising: an interactive wireless network interface for mobile or laptop or computers for downloading and streaming live or into the dongle or wireless media adapter. The subscriber unit comprising an input device for receiving subscriber input indicative of 4K media contents or movies selection, high capacity SSD hard drive for storing 4K media contents or movies; dongle or wireless media adapter for receiving an input feed of 4K media contents or movies; remote connect feature to monitor usage static or illegal distribution of 4K media contents or movies; and proprietary software module for encryption & decryption 4K media contents or movies and delivering 4K media contents or movies to display device. The 4K media contents or movies are from media contents or movies producer/owner. The 4K media contents or movies are stored in the database in web server.

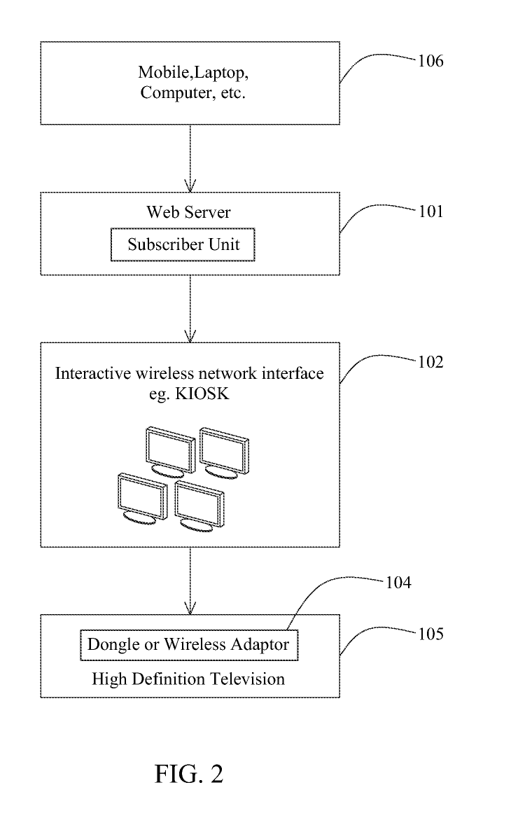

FIG. 2 shows the user or subscriber can experience viewing of 4K media contents or movies by electronic devices such as mobile, laptop, computers etc 106 or on high definition television 105 through wireless communication network or internet where a dongle or wireless adapter 104 connected to high definition television 105. Wherein, the 4K media contents or movies stored on database is transmitted to an interactive wireless network interface such as KIOSK 102 and High-Definition Multimedia Interface (HDMI) incorporated for delivering 4K media contents or movies through a dongle or wireless adapter 104 on high definition television 105.

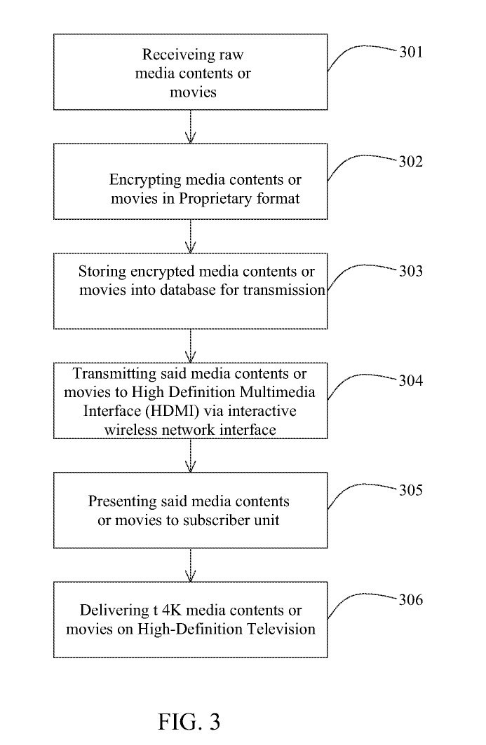

FIG. 3 shows a method for delivering 4K media contents or movies on display device, the method starts by receiving raw media contents or movies 301; encrypting said media contents or movies into proprietary format 302; storing encrypted media contents or movies into database for transmission 303; transmitting said encrypted media contents or movies to High-Definition Multimedia Interface (HDMI) via interactive wireless network interface 304, the interactive wireless network interface is physically connected with High-Definition Multimedia Interface (HDMI) and presenting said media contents or movies to subscriber unit 305 and delivering 4K media contents or movies on high definition television 306.

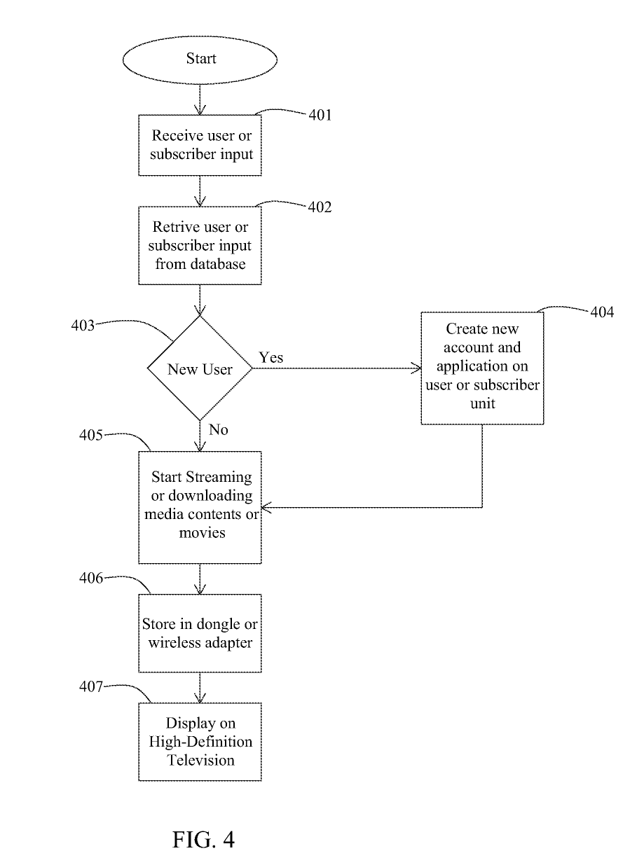

FIG. 4 shows a method for delivering of 4K media contents or movies to user or subscriber by the system of the present invention. The method starts by receiving the subscriber input 401 indicative of 4K media content or movie selection, the system having terminal management module for retrieving user or subscriber input 402 from database, if the user is a new user 403, the system creates a new account and application on user subscriber unit 404. Upon authorizing of the user or subscriber, the 4K media contents or movies starts streaming or downloading the 4K media contents or movies 405 and stores it in dongle or wireless adapter 406 to watch offline or displayed on high definition television 407 via live streaming.

In yet another embodiment of the present invention provides a method for delivering 4K media contents or movies on display device, the method comprising: receiving raw 4K media contents or movies; encrypting said 4K media contents or movies into proprietary format; storing said 4K media contents or movies into database for wireless transmission; transmitting said 4K media contents or movies into interactive wireless network interface, the interactive wireless network interface is physically connected with high-Definition Multimedia Interface (HDMI) and said 4K media contents or movies are presented to subscriber unit; receiving the subscriber input indicative of a 4K media contents or movies selection, authorizing the subscriber; decrypting the 4K media contents or movies; and delivering 4K media contents or movies by a dongle or wireless media adapter connected to the display device.

The display device includes but are not limited to high definition television such as LCDTV, LEDTV, SMART TV, HDTV, UHDTV or OLED.

The proprietary software module is for encrypting said 4K media contents or movies into proprietary format for storing in databases and decrypting said 4K media contents or movies in conjugation with dongle or wireless adapter is connected to display during delivery to the display device. The proprietary software module for encryption and decryption of 4K media contents or movies are compatible to all mobile devices and laptops.

The High-Definition Multimedia Interface (HDMI) and dongle or wireless adapter are configured to wirelessly relay of a wireless communication. Wherein, the High-Definition Multimedia Interface (HDMI) is a Digital Video Interface (DVI).

The interactive wireless network interface is physically connected to High-Definition Multimedia Interface (HDMI) comprises a subscriber unit configured to play 4K media contents or movies on an associated display device, wherein the system comprises an interface for at least one of High-Definition Multimedia Interface (HDMI), digital visual interface (DVI), and Display Port.

As a result, the present invention produces 4K media contents or movies having a 4K2K resolution that has been distributed to the display device which exhibit high realistic sensation.

The present invention is also compatible to deliver other format media contents or movies apart from 4K media contents or movies, if the television is with High-Definition Multimedia Interface HDMI.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A method for delivering 4K media contents or movies on display device, the method comprising:
receiving raw 4K media contents or movies;
encrypting said 4K media contents or movies into proprietary format;
storing said 4K media contents or movies into database for wireless transmission;
transmitting said 4K media contents or movies into interactive wireless network interface, the interactive wireless network interface is physically connected with High-Definition Multimedia Interface (HDMI) and said 4K media contents or movies are presented to subscriber unit;
receiving the subscriber input indicative of a 4K media contents or movies selection,
authorizing the subscriber;
decrypting the 4K media contents or movies; and
delivering 4K media contents or movies by a dongle or wireless adapter connected to the display device.

2. A method of claim 1, the display device is/are high definition television such as LCDTV, LEDTV, SMART TV, HDTV, and UHDTV, OLED etc.

3. A method of claim 1, wherein encrypting said 4K media contents or movies into proprietary format are done by proprietary software module for storing in the database.

4. A method of claim 1, wherein dongle or wireless adapter is connected to display device may cause the decryption of 4K media contents or movies by proprietary software module during delivery to the display device.

5. A method of claim 1, wherein the High-Definition Multimedia Interface (HDMI) and dongle or wireless adapter are configured to wirelessly relay of a wireless communication.

6. The method of claim 1, wherein the High-Definition Multimedia Interface (HDMI) is a Digital Video Interface (DVI) interface.

7. A interactive system for delivering 4K media contents or movies on display device, the system comprising:
plurality of database;
proprietary software module;
interactive wireless network interface;
High-Definition Multimedia Interface (HDMI); and
a dongle or wireless adapter;
wherein, said database is for storing raw video of 4K media contents or movies;
said proprietary software module for encrypting and decrypting of 4K media contents or movies for storage and transmission;
said interactive wireless network interface is for receiving, storing and transmitting encrypted 4K media contents or movies;
said High-Definition Multimedia Interface (HDMI) is physically connected to interactive wireless network interface which store the 4K media contents or movies for presenting to the subscriber unit; and
a dongle or wireless adapter connected to display device for transmitting the decrypted 4K media contents or movies to display device through wireless communication network.

8. The interactive system of claim 7, wherein the High-Definition Multimedia Interface (HDMI) store the 4K media contents or movies for presenting to the subscriber for rental.

9. The interactive system of claim 7, wherein the a dongle or wireless adapter have expansion slot micro SD card for downloading, streaming and storing the 4K media contents or movies to watch offline.

10. The interactive system of claim 9, wherein the micro SD card memory is expandable to 32, 64, 128 GB or more.

11. The interactive system of claim 7, wherein the dongle or wireless adapter have remote connect feature to monitor usage static or illegal distribution of 4K media contents or movies.

12. A system of 4K media contents or movies delivery to display device, the system comprising:
interactive wireless network interface for mobile or laptop or computers for downloading and streaming live or into the dongle or wireless adapter.
subscriber unit comprising an input device for receiving subscriber input indicative of 4K media contents or movies selection,
high capacity SSD hard drive for storing 4K media contents or movies;
dongle or wireless adapter for receiving an input feed of 4K media contents or movies;
remote connect feature to monitor usage static or illegal distribution of 4K media contents or movies; and
proprietary software module for encryption & decryption 4K media contents or movies and delivering 4K media contents or movies to display device.

13. The system of claim 12, the proprietary software for encryption & decryption of media contents or movies is compatible for Mobile device, laptop or all phone services.

14. The system of claim 12, wherein the 4K media contents or movies is from media contents or movies producer/owner.

15. The system of claim 12, wherein the 4K media contents or movies comprises a web based server.

16. The system of claim 12, wherein interactive wireless network interface comprises a storage server.

17. The system of claim 12, wherein interactive wireless network interface with physically connected to High-Definition Multimedia Interface (HDMI) comprises a subscriber unit configured to play 4K media contents or movies on an associated display device.

18. The system of claim 12, wherein the system comprises an interface for at least one of High-Definition Multimedia Interface (HDMI), digital visual interface (DVI), and Display Port.

19. The system of claim 12, wherein the display device comprises a high-definition television (HDTV).

20. The system of claim 12, wherein the dongle or wireless adapter communicatively couples to an electronic device such as laptop or computer or mobile or phone; and communicating the 4K media contents or movies data to a web browser of the electronic device via a web server in the a dongle or wireless adapter.
